(19) United States
(12) Patent Application Publication
(10) Pub. No.: US 2009/0056432 A1
(43) Pub. Date: Mar. 5, 2009

(54) REMOTELY OPERATED BRAKE TESTER AND METHOD OF TESTING

(76) Inventor: Joseph Steininger, Kitchener (CA)

Correspondence Address: DARYL W SCHNURR;MILLER THOMSON LLP, ACCELERATOR BUILDING, 295 HAGEY BLVD., SUITE 300, WATERLOO, ON, N2L 6R5, CA

(21) Appl. No.: 12/201,513

(22) Filed: Aug. 29, 2008

Related U.S. Application Data
(60) Provisional application No. 60/968,944, filed on Aug. 30, 2007.

(51) Int. Cl. G01L 5/28

(52) U.S. Cl. 73/132

(57) ABSTRACT

A brake tester and method testing brakes uses an elongated member that has an extended position and retracted position. The elongated member is installed between the brake pedal of a vehicle and a base and can be extended and retracted by a user from outside the vehicle using a remote. The tester is preferably used to test air brakes and is powered electronically and by air under pressure. The tester can be made to operate under electrical power alone, without pneumatic pressure.

Applicant claims the benefit of U.S. Provisional Application Ser. No. 60/968,944 filed on Aug. 30, 2007.

### BACKGROUND OF THE INVENTION

1. Field of the Invention

This invention relates to a brake tester, a combination of brake pedal and motor vehicle and to a method of operation thereof for the brakes of a motor vehicle and, more particularly, relates to a tester and method of operation for air brakes.

2. Description of the Prior Art

Truck drivers are required to check the brakes of the truck they are driving and truck drivers and/or owners of trucks are often fined if the brakes of a truck are found not to be working properly when the brakes are inspected by government authorities. Truck inspection stations are located periodically along major highways. In addition to fines, the truck can be taken off the road by government authorities until such time as the brakes are repaired. It is therefore important that truck drivers check the operation of all of the brakes on the truck that they are driving several times per day while the truck is being used. Large trucks, particularly tractor trailers, have air brakes and many wheels for which the brakes must be checked. This can be a time consuming procedure and requires two persons. One person remains in the cab and applies and releases the brake pedal as the other person observes the operation of the brakes on each of the wheels of the tractor and of the trailer. It is very important from the position of public safety that the brakes be working properly at all times.

Sometimes, when two persons are not available, a truck driver will forego visual inspection and will attempt to “test” the brakes simply by moving the vehicle forward or rearward and applying the brakes within the cab. Such a test does not enable the driver to determine whether the brakes at each wheel are operating properly.

The Foster U.S. Pat. No. 6,530,261 issued Mar. 11, 2003 describes a semi-truck trailer brake tester system and method. The system described in the Foster patent is designed to be used when a trailer has been disconnected from the tractor and the system has a portable air compressor, pressure regulator that is connected into the air lines of the trailer and operated with a handheld control to enable a single person to conduct the entire brake test process. The device described in the Foster patent is expensive, complex and cumbersome and is not suitable for use in testing the brakes of a motor vehicle when the vehicle is enroute or when the trailer is attached to the tractor.

### SUMMARY OF THE INVENTION

It is an object of the present invention to provide a brake tester that is relatively inexpensive and simple to use to test the brakes remotely at any time by one person acting alone by pressing and releasing the brake pedal remotely while observing the movement of each of the brakes in succession.

It is a further object of the present invention to provide a brake tester that operates to physically depress and release the brake pedal of a vehicle remotely while one user operates the tester from outside the vehicle while observing the movement of each of the brakes in succession.

A brake tester to enable brakes of a motor vehicle to be tested by one user acting alone where the vehicle has a cab and a brake pedal within the cab and the tester comprises an elongated member with two ends removably connected between said brake pedal and a base. The elongated member has an extended position and a retracted position. The elongated member has, or is connected to, a power source and has a controller thereon. The controller is operable by a remote outside of said cab to remove the elongated member between the extended position and the retracted position, thereby depressing and releasing the brake pedal respectively while the user is in a position to observe the operation of the brakes.

A tester and motor vehicle in combination for use in enabling one user, acting alone, to test brakes of the vehicle is provided. The motor vehicle has a cab with a brake pedal in the cab and a base for mounting the tester. The combination comprises the tester with an elongated member having two ends removably connected between the brake pedal and the base. The elongated member has an extended position and retracted position and has, or is connected to, a power source. The tester has a controller that is controllable by a remote. The remote is operable by the user outside of the cab to extend and retract the elongated member, thereby depressing and releasing respectively the brake pedal.

A method of testing the brakes of a motor vehicle by one user acting alone uses a tester having an elongated member with an extended position and a retracted position. The elongated member has two ends, being a first end and a second end, a first end having a fastener thereon to removably connect the first end to the brake pedal. The second end is connected to a base and the elongated member is connected to a power source. The tester has a controller that is controllable by a remote, the motor vehicle having a brake pedal. The method comprises mounting the tester between the brake pedal and a base, said user being in a position to observe an operation of each brake on each wheel of the motor vehicle in succession, operating the remote to extend and retract the elongated member, thereby depressing and releasing the brake pedal respectively, repeating the operation of the remote and tester for each brake.

### BRIEF DESCRIPTION OF THE DRAWINGS

FIG. 1 is a schematic side view of a brake tester;

FIG. 2 is a schematic side view of a tester with Velcro (a trade mark) fasteners on each end;

FIG. 3 is a perspective view of a further embodiment of a brake tester;

FIG. 4 is a top view of the brake tester of FIG. 3;

FIG. 5 is a side view of the brake tester of FIG. 3;

FIG. 6 is an end view of the brake tester of FIG. 3;

FIG. 7 is a perspective view of an elongated member for the embodiment shown in FIG. 3;

FIG. 8 is a top view of the elongated member of FIG. 7;

FIG. 9 is a side view of the elongated member of FIG. 7; and

FIG. 10 is an end view of the elongated member of FIG. 7.

### DETAILED DESCRIPTION OF A PREFERRED EMBODIMENT

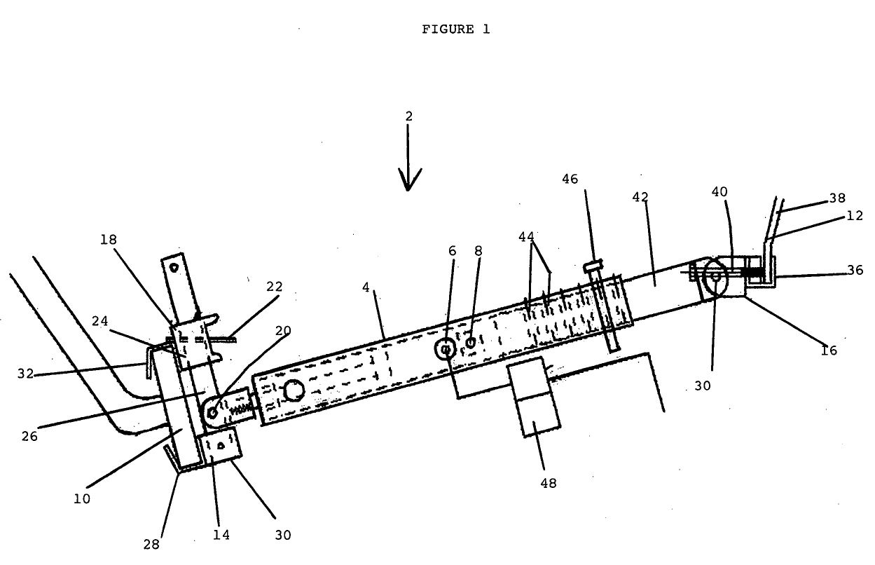

In FIG. 1, a brake tester 2 has an elongated member 4 with a switch 6 and an air inlet 8. The tester 2 is connected between a brake pedal 10 and a base 12. The base 12 can be located on an underside of the driver's seat or can be located at a front of the seat or even on a steering wheel of the vehicle (not shown). The tester has a first end 14 and a second end 16. The first end 14 is connected to an adjustable retainer 18 by a hinge 20. The retainer 18 is adjustable by a handle 22 that causes a bracket 24 to move along a post 26. The post 26 has a series of projections and indentations thereon so that the distance of the bracket along the post can be almost infinitely adjusted. A first arm 28 is connected to a fixed end 30 of the retainer 18 and the second arm 32 is affixed to the bracket 24.

The second end 16 has a hinge 34 connected to a retainer 36 which is connected to a seat bracket 38 by a bolt 40. The second end 16 has a bar 42 which has a series of openings 44 therein shown by way of dotted lines. A pin 46 is sized to fit through the elongated member 4 and through any one of the openings 44 to allow the bar 42 to slide inward or outward relative to the elongated member 4, thereby adjusting the overall length of the tester 2 when the elongated member is in the retracted position so that it spans the distance between the base (which in this drawing is the seat bracket 38) and the brake pedal 10 without depressing the brake pedal 10. The length of the elongated member 4 can be adjusted when the elongated member is in the retracted position without using the remote. The elongated member has several retracted positions. Preferably, the elongated member 4 is a pneumatic cylinder connected to an air supply (not shown) located within the cab (not shown) of the motor vehicle (not shown). Preferably, the cab is a tractor (not shown) and the tractor is connected to a trailer (not shown). The tester can be used to test the brakes of the tractor and of the trailer. If the cab is not connected to a trailer, the tester can still be used to test the brakes of the tractor. The switch 6 is connected to an electrical supply within the cab (not shown) and is operable by a remote 48. The remote 48 causes the elongated member 4 to extend or contract in accordance with the appropriate operation of the remote 48.

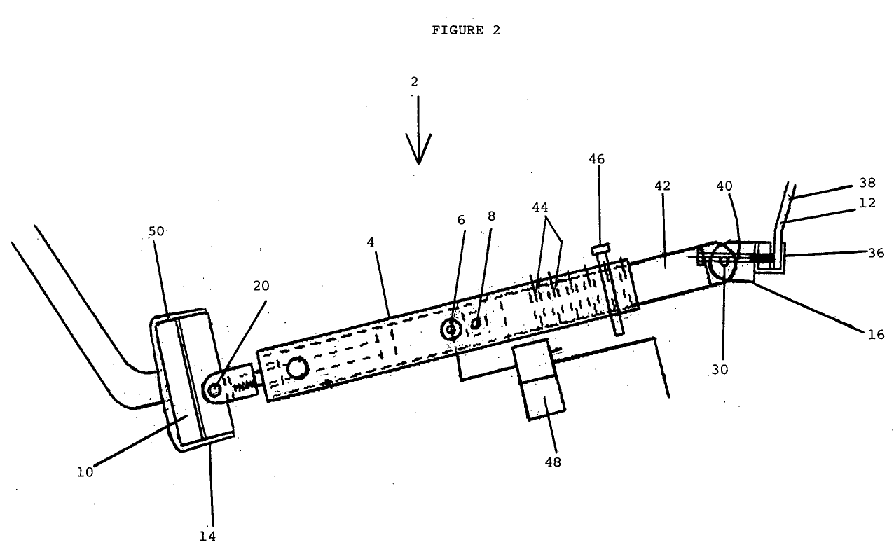

Instead of the retainers 18 and 36, Velcro (a trademark) or other suitable attachment means can be used to connect the tester 2 to both the brake pedal 10 and to the base 12. A Velcro fastener is described as a hook and loop attachment. In FIG. 2, Velcro straps 50 attached to a support post 52 are used as fasteners at the first end 14. It is also contemplated that Velcro straps can be used as fasteners at the second end 16. The Velcro straps are hook and loop fasteners. The same reference numerals are used in FIG. 2 as those used in FIG. 1 for the components that are similar.

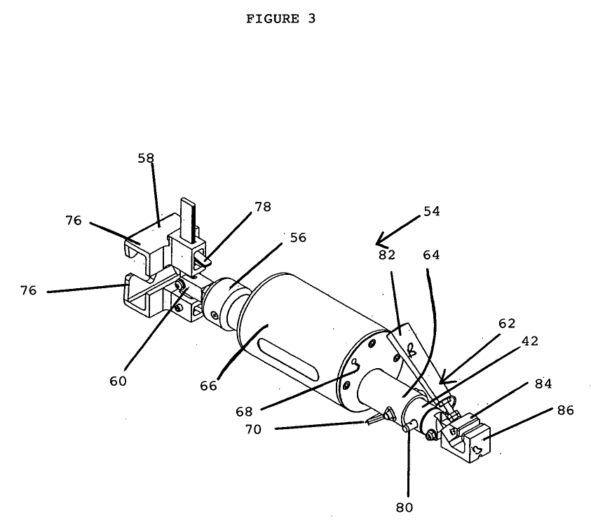

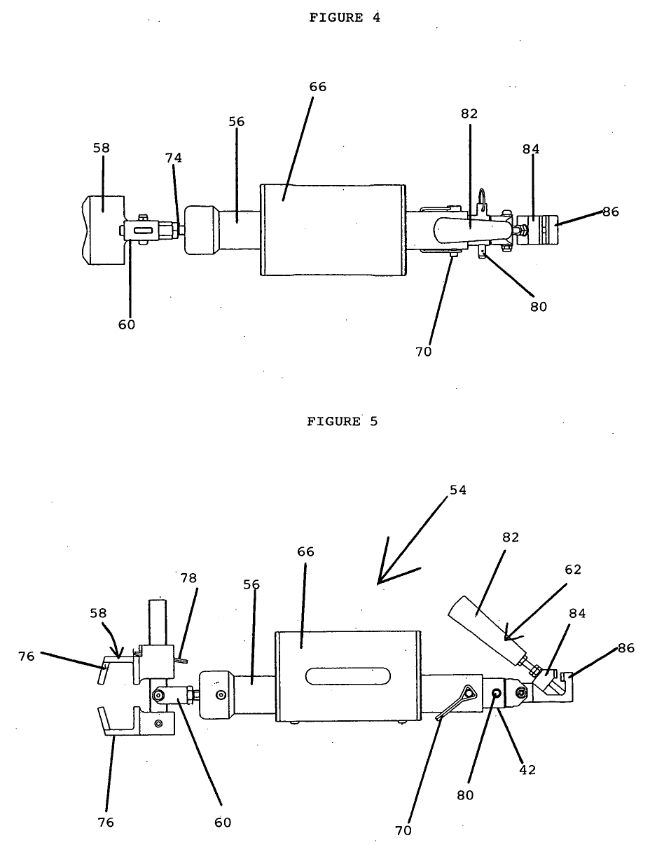

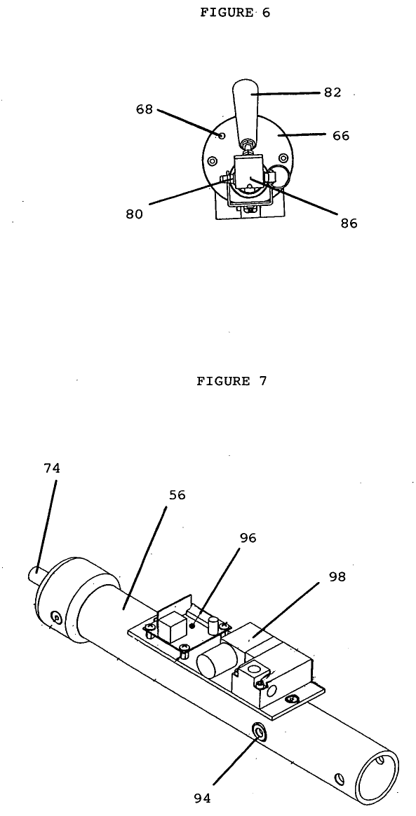

In FIGS. 3 to 6, a brake tester 54 has an elongated member 56 with an adjustable brake pedal clamp 58 at a rod end 60 and an adjustable clamp 62 at a cylinder end 64. A housing assembly 66 surrounds the elongated member 56. The bar 42 is concentrically mounted within the cylinder end 64 of the elongated member 56. When the locking pin 70 is unlocked, the post slides freely within the cylinder end 64 of the elongated member 56. When the locking pin 70 is locked, the bar 42 is in a fixed position within the cylinder end 64. An electrical connection 68 is located in the housing assembly 66. The elongated member 56 has a rod 74 extending outward there from at the rod end 60. An adjustable clamp 58 is mounted on the rod end 60 to clamp onto a brake pedal (not shown). The clamp 58 has two U-shaped sides 76 and the sides 76 can be adjusted relative to one another by locking or unlocking an adjustment lever 78. In the bar 68, there is located a quick release pin 80 and the clamp 62 can be adjusted to clamp onto a steering wheel, driver's seat or other base (all of which are not shown in the drawings and are conventional). The clamp 62 has a handle 82 that can be rotated to open or close the jaws 84, 86 of the clamp 62. The same reference numerals are used in FIGS. 4, 5, and 6 for those used in FIG. 3 for those components that are identical.

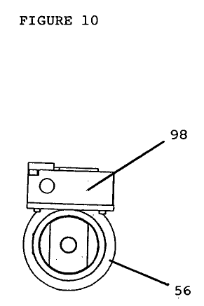

In FIG. 7, there is shown a perspective view of the elongated member 56, which is preferably a pneumatic cylinder. The same reference numerals are used as those used in FIGS. 3 to 6 for those components that are identical. The elongated member 56 has a pneumatic hose bushing 94 with an electrical control chip or controller 96 and a solenoid valve 98. The chip 96 controls the solenoid valve. When the remote (not shown in FIGS. 7 to 10), is depressed, the electrical control chip 96 is activated to extend add pressurized air to the elongated member 56 to the rod 74 and thereby depress the brake pedal 10. Alternatively, the remote can be depressed to relieve the pressurized air from the elongated member 56, thereby retracting the rod 74 and releasing the brake pedal.

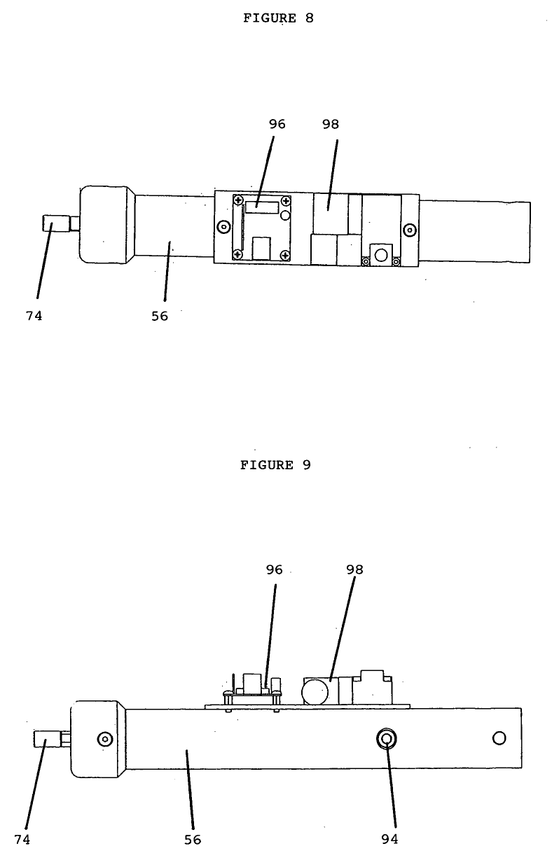

In FIGS. 8 to 10, the same reference numerals are used as those used in FIG. 7 for those components that are identical.

In operation, with the motor vehicle on a horizontal surface, a user adjusts the length of the tester 2 when the tester 2 is in a retracted position by removing the pin 46 and moving the bar 42 inward or outward relative to the elongated member 4 so that the tester extends from the brake pedal to the base, but does not depress the brake pedal. The pin is reinserted to hold the bar in the position chosen and the ends of the tester 2 are connected to the base and to the brake pedal. The user then connects the air supply and the electrical supply and takes the remote and exits the vehicle. The user releases the parking brakes and turns off the engine before exiting the vehicle. Preferably, the air pressure is at maximum (120 psi). The vehicle must be on a solid, level surface and the wheels locked. The user inspects the operation of the brakes on one wheel of the motor vehicle by standing beside that wheel to observe the operation of the brakes while operating the remote to extend and retract the brake tester 2. When an appropriate button on the remote is depressed, the tester is extended, thereby depressing the brake pedal and activating the brakes of the vehicle. When a user has properly inspected the operation of one brake (sometimes by extending and retracting the tester several times) the user will move on to the next brake. When another button on the remote is depressed, or, alternatively, the same button is depressed a second time, the tester will retract, thereby releasing the brake pedal and releasing the brakes. A user acting alone can therefore operate the brakes from outside the vehicle and observe the physical movement of the brakes on each wheel being tested in succession. When all of the brakes on the motor vehicle have been tested satisfactorily, the user returns to the vehicle and releases and removes the tester from the brake pedal and base. The tester also enables a user acting alone to check the brake lights of the vehicle (eg. tractor and trailer).

While the tester has been described for use with a motor vehicle, the tester is preferably used with a tractor trailer or truck having air brakes. The tester can also be designed to operate by electrical power alone enabling the tester is used in motor vehicles that have air brakes or do not have air brakes.

When the tester 54 is used, the user operates the tester in a manner similar to the manner in which the tester 2 is operated.

I claim:

1. A brake tester to enable brakes of a motor vehicle to be tested by one user acting alone, said vehicle having a cab and a brake pedal within said cab, said tester comprising an elongated member with two ends removably connected between said brake pedal and a base, said elongated member having an extended position and a retracted position, said elongated member having, or being connected to, a power source and having a controller thereon, said controller being operable by said user using a remote outside of said cab to move said elongated member between said extended position and said retracted position, thereby depressing and releasing said brake pedal respectively while said user is in a position to observe an operation of said brakes.

2. A tester as claimed in claim 1 wherein said brakes are air brakes and said tester is connected to a source of compressed air within said cab and said elongated member is a pneumatic cylinder.

3. A tester as claimed in claim 2 wherein said cab has an electrical power source, said tester being connected to said electrical power source to power said controller.

4. A tester as claimed in claim 1 wherein said cab has an electrical power source and said tester is connected to said electrical power source to power said tester.

5. A tester as claimed in claim 3 wherein said retracted position occurs when said pneumatic cylinder is contracted, and said extended position occurs when said pneumatic cylinder is extended.

6. A tester as claimed in claim 1 wherein said elongated member, while in said retracted position, has an adjustable length to properly fit said tester between said brake pedal and said base.

7. A tester as claimed in claim 6 wherein said elongated member has two portions that are slidable longitudinally relative to one another, said portions having suitable openings that can receive a removable pin to lock said portions in position relative to one another.

8. A tester as claimed in claim 1 wherein said two ends being an first end and a second end, said first end having a fastener thereon to removably connect said first end to said brake pedal.

9. A tester as claimed in claim 8 wherein said second end also has a fastener thereon.

10. A tester as claimed in claim 1 wherein said tester is mounted between a driver's seat or an area beneath said driver's seat and said brake pedal, said tester being at an appropriate angle to said brake pedal to depress or release said brake pedal.

11. A tester as claimed in claim 1 wherein said tester is mounted between a steering wheel and said brake pedal.

12. A tester as claimed in claim 3 wherein said elongated member has several retracted positions to enable said elongated member to be installed between the brake pedal and the base without depressing the brake pedal.

13. A tester as claimed in claim 1 wherein said remote is wireless.

14. A tester and motor vehicle in combination for use in enabling one user, acting alone, to test brakes of said vehicle, said motor vehicle having a cab with a brake pedal, in said cab and a base for mounting said tester, said combination comprising said tester with an elongated member having two ends removably connected between said brake pedal and the base, said elongated member having an extended position and a retracted position, said elongated member having, or being connected to a power source, said tester having a controller that is controllable by a remote, said remote being operable by said user outside of said cab to extend and retract said elongated member, thereby depressing and releasing respectively said brake pedal.

15. A combination as claimed in claim 14 wherein said brakes are air brakes and said tester is connected to a source of compressed air within sad cab, said elongated member being a pneumatic cylinder.

16. A combination as claimed in claim 14 wherein said tester is connected to an electrical power source to power said controller.

17. A combination as claimed in claim 14 wherein said elongated member has an adjustable length when said elongated member is in said retracted position.

18. A combination as claimed in claim 14 wherein said tester is powered by an electrical power source.

19. A combination as claimed in claim 14 wherein said two ends are a first end and a second end, said first end having a fastener thereon.

20. A method of testing brakes of a motor vehicle by one user acting alone using a tester having an elongated member with an extended position and a retracted position, said elongated member having two ends, being a first end and a second end, said first end having a fastener thereon to removably connect said first end to said brake pedal, said second end being connected to a base, said elongated member being connected to a power source, said tester having a controller that is controllable by a remote, said motor vehicle having a brake pedal, said method comprising mounting said tester between said brake pedal and a base, said user being in position to observe an operation of each brake on each wheel of said motor vehicle in succession, operating said remote to extend and retract said elongated member, thereby depressing and releasing said brake pedal respectively, repeating said operation of said remote and said tester for each brake.
